(19) United States
(12) Patent Application Publication
(10) Pub. No.: US 2008/0140331 A1
(43) Pub. Date: Jun. 12, 2008

(54) METHOD OF CALIBRATING TEMPERATURE COMPENSATED SENSORS

(76) Inventor: VICTOR ALEXANDROVICH KALININ, Oxford (GB)

Correspondence Address: KEUSEY, TUTUNJIAN & BITETTO, P.C., 20 CROSSWAYS PARK NORTH, SUITE 210, WOODBURY, NY, 11797, US

(21) Appl. No.: 12/035,777

(22) Filed: Feb. 22, 2008

(30) Foreign Application Priority Data
Dec. 12, 2007 (GB) 0724243.1
Feb. 11, 2008 (GB) 0802498.6

(51) Int. Cl. G01D 18/00; G01N 29/30

(52) U.S. Cl. 702/88; 702/103; 73/1.88; 73/1.82

(57) ABSTRACT

A method of calibrating an individual sensor whose output varies with at least one operating condition. A generic calibration curve is produced for the variation of the sensor reading with the at least one operating condition for the particular sensor type of the individual sensor. Calibration readings are then taken for the individual sensor at just a small number of discrete values for the at least one operating condition which fall within the full range of operating values for the at least one operating condition for which the sensor is to be calibrated. Using the calibration readings, the generic calibration curve is then scaled in order to fit the generic curve to the individual sensor.

### BACKGROUND OF THE INVENTION

1. Field of the Invention

The present application relates to methods for calibrating sensors for measuring physical parameters in which reading of the sensor varies depending upon conditions such as temperature, so that compensation of the reading from the sensor must be done in order to obtain an accurate value for the measured parameter.

2. The Prior Art

The application deals with physical sensors for measuring such quantities as mechanical strain, force, acceleration, pressure, torque, electric and magnetic fields, power, etc. Very often, the sensor reading varies with surrounding conditions, in particular on the ambient temperature, and the only way to compensate this dependence is to measure the temperature along with the physical quantity of interest. In the approach known in the prior art, the sensor is calibrated within the entire working range of temperatures and then the temperature compensated reading is obtained as a result of processing of the information provided by the sensing element in a microprocessor on the basis of a certain calibration model of the sensor.

More particularly, if the aim is to measure the physical quantity M within the range of temperatures T from Tₘᵢₙ to Tₘₐₓ, the sensing element provides information about M and T in the form of two independently measured physical quantities Fₘ and Fₜ. Depending on the sensing technique used they can be currents, voltages (in the case of piezoresistive, piezoelectric, Hall effect, etc. sensors), capacitances (capacitive MEMS sensors), frequencies or time and phase delays (sensors based on resonators and delay lines) and other quantities that can be easily converted into a digital format by electronic circuitry. In general, both Fₘ and Fₜ depend on M and T:

Fₘ=Fₘ(M,T), (1)

Fₜ=Fₜ(M,T), (2)

but their dependencies are different and these dependencies are established by sensor calibration within the temperature range of interest. This produces a calibration model, usually either in the form of look-up tables or in the form of polynomials approximating the actual calibration results. Combinations of both can also be used in order to reduce complexity of the calibration model. For example, if Fₘ and Fₜ depend on M linearly or piece-wise linearly, then the following model can be used:

$$\begin{matrix}{F}_{m} = \{ \begin{matrix}{S}_{p} ( T ) M + {F}_{0} ( T ) , & M \geq 0 , \\ {S}_{n} ( T ) M + {F}_{0} ( T ) , & M < 0\end{matrix} & ( 3 ) \\ {F}_{t} = {a}_{1} - {a}_{2} \overline{T} {a}_{3} M + {a}_{4} {T}^{2} + {a}_{5} {T}^{3} , & ( 4 )\end{matrix}$$

where the sensitivities S_{p,n} and the offset F₀ as functions of temperature can be represented by look-up tables in a number of discrete temperature calibration points covering the whole temperature range of interest:

| T | Sₚ | Sₙ | F₀ |
|---|---|---|---|
| T₁ | Sₚ₁ | Sₙ₁ | F₀₁ |
| T₂ | Sₚ₂ | Sₙ₂ | F₀₂ |
| . . . | . . . | . . . | . . . |
| Tₙ | Sₚₙ | Sₙₙ | F₀ₙ |

A practical number of temperature calibration points can be from 10 to 5 for a typical automotive temperature range from −40° C. to +125° C. (it depends on a character of temperature variation of S_{p,n} and F₀). If needed the look-up tables can be expanded on a larger number of points with a smaller temperature step by means of interpolation.

After developing the calibration model, the temperature-compensated value of M, as well as the temperature T, can be found from the sensor readings Fₘ and Fₜ by solving simultaneous equations Eqs. (1) and (2) or Eqs. (3) and (4) in the microprocessor.

Any individual physical sensor is fully characterised by a set of calibration parameters, for instance, polynomial coefficients α₁₋₅ and values in the look-up tables Sₚ₁₋ₙ, Sₙ₁₋ₙ, F₀₁₋ₙ.

This prior art approach is fine in theory but has its practical limitations. Individual sensors slightly differ from each other because of fabrication tolerances so that the individual calibration parameters also differ from each other. If the difference is small all the sensors can be described by the same generic calibration parameters α₁₋₅, Sₚ₁₋ₙ, Sₙ₁₋ₙ, F₀₁₋ₙ that can be found as an average of the individual calibration parameters. In this case replacing of the actual individual calibration parameters by the generic ones for a particular sensor does not cause unacceptably large additional errors in the measured value of M. In practice, then, only a first batch of sensors (sufficiently large to be statistically representative) needs to be calibrated within the entire temperature range from Tₘᵢₙ to Tₘₐₓ in order to find generic calibration parameters. The rest of sensors can be supplied without their calibration just relying on high repeatability of the manufacturing process. This is a standard approach allowing considerable reduction of the sensor cost by excluding a calibration cost from it.

Very often, however, variations in the sensor characteristics are too large to be able to use a single set of generic calibration parameters for all sensors without calibrating them. An example of this situation is demonstrated in FIG. 1, which shows errors in measuring engine output torque by 27 SAW resonant sensors installed on flexplates in the case if their individual calibration parameters are replaced by the generic ones. The curves are plotted against temperature for the measured torque value M=800 Nm, and show that the maximum error exceeds 100% of reading which is obviously unacceptable. In this case the prior art approach is to produce an individual calibration of each sensor within the entire temperature range. Bearing in mind that it needs to be done in relatively large number of temperature points, this process considerably increases the sensor cost. It may even be not feasible in some cases, for instance, if the sensor is installed on a large metal part and needs to be calibrated together with this part. In this case it may take 1-3 hours in order to reach a steady state at each temperature point.

The aim of the invented method is therefore to reduce considerably time and cost of individual calibration of the sensors with a large spread of characteristics by means of reduction of the number of temperature calibration points down to one or two.

### SUMMARY OF THE INVENTION

According to the present invention there is provided a method of calibrating an individual sensor whose output varies with at least one operating condition comprising the steps of: producing a generic calibration curve for the variation of the sensor reading with the at least one operating condition for the particular sensor type of said individual sensor; taking calibration readings for the individual sensor at just a small number of discrete values for the at least one operating condition which fall within the full range of operating values for the at least one operating condition for which the sensor is to be calibrated; and using said calibration readings to scale the generic calibration curve in order to fit the generic curve to the individual sensor.

A method in accordance with the present invention has the advantage that it enables accurate calibration information to be produced for individual sensors having a large spread of characteristics in a time efficient and therefore cost effective manner.

Preferably, the step of producing a generic calibration curve for the particular sensor type comprises producing detailed calibration curves for a sample number of sensors, e.g. 100, of the particular sensor type within the full operating range for the at least one operating condition, and then calculating an average curve from the calibration curves obtained for the sample number of sensors, said average curve being used as the generic calibration curve.

In one embodiment, the at least one operating condition is a single operating condition, in particular temperature, both the measurements for generating the generic calibration curve as well as the calibration readings for the individual sensor being taken at discrete temperatures covering the full temperature operating range of the sensor type. It is, however, also possible to apply the method of the present invention to obtain calibration data for more than one operating parameter which impacts on the sensor readings in a manner which it is preferred to avoid.

In one embodiment no more than three calibration readings are taken for the individual sensor, advantageously spread across the operating range of the sensor, and in particular including one at room (ambient) valve, such as ambient temperature, the latter having the particular advantage that minimal heating or cooling of the sensor will be required to take the ambient reading, hence speeding up the process. It has been found to be particularly effective to take just two calibration readings for the individual sensor, by which a good compromise is achieved between time taken to calibrate and accuracy. Applying the method with just a single calibration reading has also been found to produce acceptable results. One application for the invention is for SAW sensors installed on flexplates of motor vehicles.

### BRIEF DESCRIPTION OF THE DRAWINGS

In order that the invention may be well understood, there will now be described an embodiment thereof given by way of example, reference being made to the accompanying drawings, in which:

FIG. 1 is a graph illustrating the error in the measurement obtained from a number of SAW sensors using temperature compensation calibration according to the prior art practice;

FIG. 2 is a graph illustrating the error in the measurement obtained from a number of SAW sensors using temperature compensation calibration according to the present invention taking just a single calibration measurement for each sensor; and

FIG. 3 is a graph illustrating the error in the measurement obtained from a number of SAW sensors using temperature compensation calibration according to the present invention using two-point calibration at 20 degrees and 90 degrees.

### DETAILED DESCRIPTION OF THE PREFERRED EMBODIMENT

The steps of a calibration method embodying the invention are described hereinafter in connection with temperature calibration of a SAW based sensor, although it will be understood that the method can also be used for calibrating other parameters effecting readings from a sensor and/or other types of sensor.

After developing a high-volume fabrication process for a particular type of a sensor the sensor manufacturer produces and calibrates the first batch of sensors (say, 100 devices to be statistically representative) within the full range of temperatures from Tₘᵢₙ to Tₘₐₓ in a sufficiently large number of temperature intervals (typically 5 to 10 discrete points).

This is achieved in practice by heating up or cooling down each individual sensor to a required calibration temperature point Tᵢ (i=1 . . . N) and taking the two readings, Fₘ and Fₜ, at a number of predefined values of measured torque value M. In the case of the model described by Eqs. (3) and (4), only three values can be used, negative Mₙ, 0, and positive Mₚ, in order to find α₃, the sensitivities S_{p,n} and the offset F₀ at each calibration temperature point. The rest of the coefficients α₁₋₅ are calculated on the basis of least mean square errors to fit the temperature calibration curves.

The calibration data α₁₋₅, S_{p,n}(T), F₀(T) is calculated for each sensor from the batch and then a generic set of calibration parameters α₁₋₅, S_{p,n}(T), and F₀(T) is found by means of averaging. This step is similar to the standard approach described above. It should be noted here that the set of calibration parameters and the calibration model for some sensors might differ from those described by Eqs. (3) and (4) above, which are given merely as an example. However, the skilled person will know or being able to derive the required equations for any sensor using his common knowledge and without inventive thought, and hence he does not need to be taught those equations in order to put the subject invention into practice.

Once the calibration curve has been formulated, each production sensor is calibrated only at one or two temperature points, depending on the spread of the sensor characteristics and acceptable calibration errors. For instance, the single temperature calibration point can be room temperature T₀=20° C. One of the two calibration points can also be room temperature T₀=20° C. and the second point can be an engine operating temperature T_{c}=90° C. if the sensor is aimed at engine output torque measurement. Selection of the calibration temperatures T₀ and T_{c} depends on the application, the temperature range and the spread of the sensor characteristics. It is, though preferable that the two values are spread across the operating temperature range of the sensor, or, in the case of a single temperature reading, is not close to either end of the operating range of the sensor.

Generic calibration parameters α₁₋₅, S_{p,n}(T), and F₀(T) are then corrected for this particular sensor on the basis of the obtained information. Correction method is designed in such a way that it provides zero calibration errors either at one temperature T₀ or at two temperatures, T₀ and T_{c}.

As an example, consider the correction method for a sensor described by Eqs. (3) and (4) in the case of one-point calibration. In this case, the individual calibration data are:

F₀₀=Fₘ(0,T₀), (5)

Fₜ₀=Fₜ(0,T₀), (6)

S_{p,n0}=[F_{m,}(M_{p,n},T₀)−F_{m,}(0,T₀)]/M_{p,n,} (7)

Sₜ₀={[F_{t,}(Mₚ,T₀)−F_{t,}(0,T₀)]/Mₚ+[F_{t,}(Mₙ,T₀)−F_{t,}(0,T₀)]/Mₙ}/2, (8)

The correction of the generic calibration parameters is performed in the following way. The individual calibration coefficients

α₃′=−Sₜ₀, (9)

α₁′=Fₜ₀+a₂T₀−a₄T₀²−a₅T₀³ (10)

replace the relevant generic coefficients and each value in the generic look-up tables is re-calculated according to the equations:

F₀′(T)=F₀(T)+F₀₀−F₀(T₀), (11)

S_{p,n}′(T)=S_{p,n}(T)+S_{p,n0}−S_{p,n}(T₀). (12)

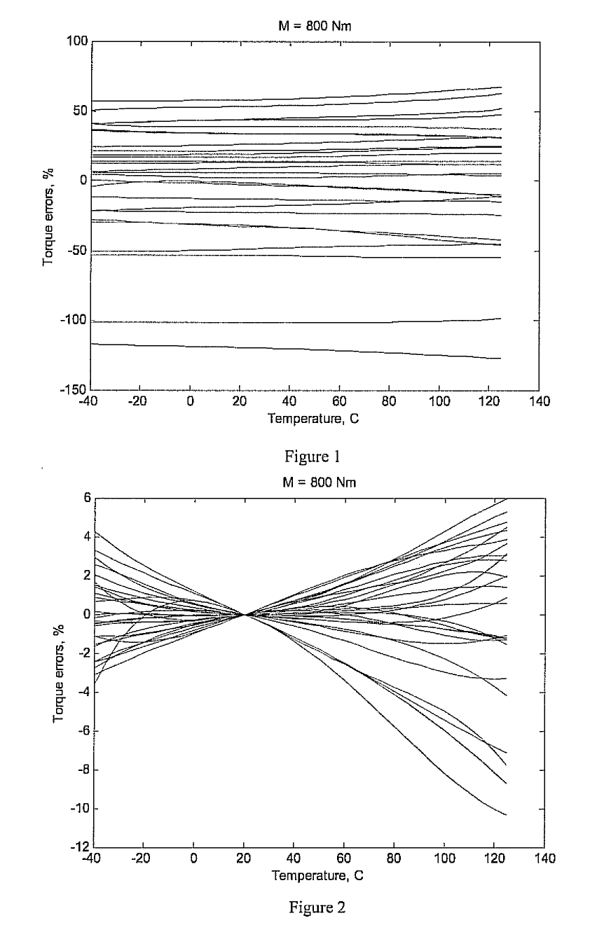

Coming back to the example of the SAW flexplate torque sensor shown in FIG. 1, the correction procedure applied after one-point calibration allows achieving a considerable reduction of the errors in comparison with the case when the individual calibration is not performed at all. FIG. 2 shows the errors in measuring torque against temperature in the case of one-point calibration at T₀=20° C. and the measured torque M=800 Nm. Maximum error is now reduced to 10% of reading. It may be acceptable for some applications but if it is still too large then a two-point calibration can be used.

Consider now the correction method for the sensor described by Eqs. (3) and (4) in the case of two-point calibration. Apart from the data described by Eqs. (5)-(8), the individual calibration data includes offsets and torque sensitivities measured at the second calibration point T_{c}:

F_{0c}=Fₘ(0,T_{c}), (13)

F_{tc}=Fₜ(0,T_{c}), (14)

S_{p,nc}=[F_{m,}(M_{p,n},T_{c})−F_{m,}(0,T_{c})]/M_{p,n}, (15)

S_{tc}={[F_{t,}(Mₚ,T_{c})−F_{t,}(0,T_{c})]/Mₚ+[F_{t,}(Mₙ,T_{c})−F_{t,}(0,T_{c})]/Mₙ}/2. (16)

As a result of correction of the generic calibration data the new individual calibration coefficients are as follows:

α₃′=−(Sₜ₀+S_{tc})/2, (17)

α₂′=[Fₜ₀−F_{tc}+a₄(T_{c}²−T₀²)+a₅(T_{c}³−T₀³)]/(T_{c}−T₀), (18)

α₁′=F_{tc}+α₂′T_{c}−a₄T_{c}²−a₅T_{c}³. (19)

The corrected look-up tables are described by the equations:

F₀′=F₀(T)+F₀₀−F₀(T₀)+[F_{0c}−F₀(T_{c})−F₀₀+F₀(T₀)](T−T₀)/(T_{c}−T₀), (20)

C_{p,n}′(T)=C_{p,n}(T)+C_{p,n0}−C_{p,n}(T₀)+[C_{p,nc}−C_{p,n}(T_{c})−C_{p,n0}+C_{p,n}(T₀)]T−T₀)/(T_{c}−T₀). (21)

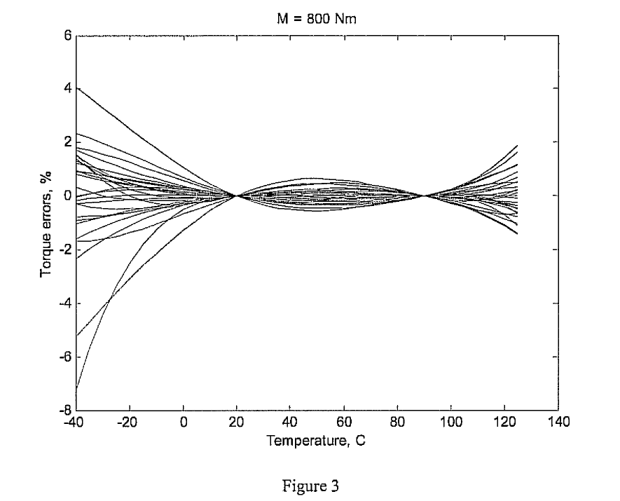

FIG. 3 illustrates reduction of the torque measurement errors achieved in the case of two-point calibration for T₀=20° C. and T_{c}=90° C. and the measured torque value of 800 Nm. One can see that a further considerable improvement of the sensor accuracy can be achieved in comparison with one-point calibration within a wide temperature range.

If the two-point calibration is performed by the sensor manufacturer then it allows reduction of the calibration time at least by a factor of four. If the two-point calibration is performed by the OEM during end-of-line tests then time and energy saving will be even larger.

The particular implementations of the correction methods for the generic calibration parameters described by Eqs. (9)-(12) for one-point calibration and by Eqs. (17)-(21) for two-point calibration are presented here just as examples. The methods can be easily modified to suit any calibration model, and it is the overall approach of fitting the generic data to the measured values for a particular sensor which is essential to the invention. Formulation of calibration equations for different sensors corresponding with those set out above will be within the practical skill of skilled reader and will not, therefore, be taught any further herein. The main requirement for the calibration equations is to adjust the calibration parameters in such a way that the calibration errors for an individual sensor become zero at the temperatures where calibration is performed.

A further reduction of the errors can be achieved if a third temperature calibration point is added, that is a third discrete calibration reading is taken for each individual sensor so as to further improve the accuracy of the fit of the calibration curve against the actual temperature response of the sensor. Again, the individual calibration parameters are obtained in this case by correcting the generic calibration parameters on the basis of the calibration data in such a way that the calibration errors turn into zero at three temperatures where calibration was performed.

What is claimed is:

1. A method of calibrating an individual sensor whose output varies with at least one operating condition comprising the steps of:
producing a generic calibration curve for the variation of the sensor reading with the at least one operating condition for the particular sensor type of said individual sensor;
taking calibration readings for the individual sensor at just a small number of discrete values for the at least one operating condition which fall within the full range of operating values for the at least one operating condition for which the sensor is to be calibrated; and
using said calibration readings to scale the generic calibration curve in order to fit the generic curve to the individual sensor.

2. A method according to claim 1, wherein the step of producing a generic calibration curve for the particular sensor type comprises:
producing detailed calibration curves for a sample number of sensors of the particular sensor type covering the full operating range for the at least one operating condition; and
calculating an average curve from the calibration curves obtained for the sample number of sensors, said average curve being used as the generic calibration curve.

3. A method according to claim 1, wherein the at least one operating condition is temperature, and wherein both measurements for generating the generic calibration curve as well as the calibration readings for the individual sensor being taken at discrete temperatures covering the full temperature operating range of the sensor type.

4. A method according to claim 1, wherein no more than three calibration readings are taken for the individual sensor.

5. A method according to claim 4, wherein a calibration reading for the individual sensor is taken at an ambient value of the operating condition.

6. A method according to claim 4, wherein only two discrete calibration measurements are taken for the individual sensor.

7. A method according to claim 6, wherein neither of said two measurements are taken proximate to an end point of the operating range of the sensor.

8. A method according to claim 1, wherein scaling the generic calibration curve in order to fit the generic curve to the individual sensor comprises:
fitting the calibration curve such that it exactly matches response of the individual sensor at the values of the operating parameter at which the calibration readings for the individual sensor are taken.

9. A method according to claim 1, wherein the sensor is a SAW sensor.

10. A method according to claim 1, wherein the sensor is a SAW sensor and the method additionally includes the step of:
installing the SAW sensor on a flexplate of a motor vehicle.
